(19) United States
(12) Patent Application Publication
(10) Pub. No.: US 2026/0305627 A1
(43) Pub. Date: Oct. 8, 2026

(54) A slaughtered pig part processing plant and a method of retaining a slaughtered pig part by a hook

(71) Applicant: FRONTMATEC GROUP APS, Kolding (DK)

(72) Inventor: Kim Maibøll PEDERSEN, Kolding (DK)

(73) Assignee: FRONTMATEC GROUP APS, Kolding (DK)

(21) Appl. No.: 19/483,054

(22) PCT Filed: May 7, 2024
(86) PCT No.: PCT/EP2024/062568

§ 371 Date: Nov. 10, 2025

(30) Foreign Application Priority Data
May 11, 2023 (DK) PA202370231

(51) Int. Cl. A22C 15/00

(52) U.S. Cl. CPC A22C 15/003

(57) ABSTRACT

A slaughtered pig part processing plant including a pig part processing station and a conveyor supporting, via respective couplings, spaced apart hooks, each hook connected to a corresponding coupling so as to allow for a turning movement of the hook, relative to the corresponding coupling, about an axis, the conveyor advancing the couplings with a corresponding hook in a machine direction from a first station for placing a pig part on a hook, towards a last station for removing the bone of the pig part from the hook, first guiding elements for engagement with the hooks at the first station, for bringing about the turning movement about the axis, from a first position to a second, pig part applying position, the axis being parallel or substantially parallel with the machine direction, each hook including a base portion contiguous with a projecting portion having proximal and distal ends.

The present invention relates to a pig part processing plant and a method for securing pig parts to a pig part assembly.

WO 2020/187692 (Frontmatec) discloses a slaughtered pig part processing plant including a plurality of pig part processing stations and a conveyor supporting via respective couplings a plurality of spaced apart clamp structures, said conveyor advancing said couplings with a respective clamp structure in a machine direction from a first station for introducing a pig part between jaws of a clamp structure, towards a last station for removing the bone of the processing pig part from the clamp structure.

The processing plant of WO'692 comprises use of a clamp structure for introducing a pig part between jaws of said clamp structure. In North America, it is standard practise to cut the feet of the hams before tumbling to loosen the skin and subsequently introduction to a processing plant. However, when the foot of the pig is cut of prior to introducing the pig part into the processing plant, the clamp structure described in WO'692 cannot hold on the pig part. Consequently, there is a need for an improved processing plant adapted for a pig part wherein the foot has been removed.

U.S. Pat. No. 9,004,988B2 (Marel) appears to disclose a system and method for processing slaughtered animals and/or parts thereof.

EP 1 658 774 (Mayekawa) appears to disclose a meat dressing/boning method and system therefor. This plant has several limitations, among others in that the retaining assemblies for holding the pig parts are limited to holding pig parts within a very narrow range of size determined by the fixed distance between the opposite plate members that define a gap for receiving a portion of the pig part. In addition, the known plant requires the operator to shift between different positions for processing the sides and the front, respectively, of the pig part.

US2015173376 (Marel) appears to disclose a system for conveying carcasses or carcass parts of quadruped slaughter animals.

U.S. Pat. No. 4,389,749 (Korhonen) appears to disclose a cutting-up process.

WO 94/10847 (EEZ-AWAY) appears to describe a carcass deboning.

WO 00/48468 (Butina ApS) appears to describe a method of deboning half pig carcasses as well as a plant for carrying out said method.

FR2598887 (Conseil Organisation formation) appears to describe a method and installation for boning a butchery rear quarter.

The object of the present invention is inter alia to provide an improved pig part processing plant and an improved pig part retaining assembly.

A further object of the invention is to provide an improved pig part processing plant that works on pig parts without feet.

The hook described herein may be movable around a vertical axis. This is beneficial as the projecting portion of the hook can be configured to point up, or substantially up, at the first station, where the pig part is introduced to the hook. This makes it easier for the process technician to place the pig part on the hook. The hook being movable around a vertical axis is also beneficial for the process technician, because this makes it easier to align the pig part with the cutting board, which may be adjusted in different ways.

Additionally, the pig part is movable around a horizontal axis when placed on the hook.

The pig part can be pressed directly over the hook, without having to move the hook, thus simplifying the process for the process technician.

Thus, a further object of the invention is to provide an improved pig part processing plant providing better work conditions for the process technician. A hook may be placed in the space between the tibia and the fibula bones. However, if the foot is cut too long, then the two bones are not jointed anymore. However, the Achilles tendon is very solid and always there, even if the foot is cut too long.

### SUMMARY

In a first aspect of the invention, a plant is provided where said plant include at least one pig part processing station and a conveyor supporting, via respective couplings, a plurality of spaced apart hooks, each hook connected to a corresponding coupling so as to allow for a turning movement of said hook, relative to said corresponding coupling, about a first axis, said conveyor advancing said couplings with a corresponding hook in a machine direction from a first station for placing a pig part on a hook, towards a last station for removing the bone of the processed pig part from the hook, said processing plant including first guiding elements for engagement with said hooks at said first station, for bringing about said turning movement about said first axis, from a first position to a second, pig part applying position, said axis being parallel or substantially parallel with said machine direction, each hook comprising a base portion contiguous with a projecting portion having a proximal end and a distal end, wherein said distal end is for pig part penetration.

In a second aspect of the invention a method of operating the plant as described herein, is provided. The method comprising the steps of:
a. Cutting off the foot of a pig part, leaving behind the Achilles tendon or part of the Achilles tendon.
b. arranging said hook in said second position, with the projecting portion being vertical or generally vertical,
c. pressing from above, said pig part without said foot onto said distal end.

Preferred embodiments providing significant benefits in solving particular problems are defined in the dependent claims. In particular, guiding elements may be provided defining together with the couplings a rack and pinion structure, to allow for a rotation of the hooks about a horizontal axis as the couplings pass along a processing station.

A processing plant of the present invention may be defined e.g. by the combination of slaughtered pig part processing stations of an existing processing plant with a replacement conveyor with hooks as defined herein, or by using hooks as defined herein replacing hooks used with an existing processing plant with a conveyor and slaughtered pig part processing stations.

### BRIEF DESCRIPTION OF THE DRAWINGS

FIG. 1 shows a top view of an embodiment of a slaughtered pig part processing plant,

FIG. 2a-2b show a first station of an embodiment of a slaughtered pig part processing plant, FIG. 2c shows a second pig part applying position (B), FIG. 2c additionally shows the angle (δ) to the vertical, and the angle (α),

FIG. 3a-3e show an embodiment of a processing plant, with hooks of the invention connected to couplings, the hook being placed in a pig part carrying position/load bearing position, FIG. 3d show part of a processing station with support means for supporting a pig part during processing, FIG. 3e shows the angle (γ) created by the support means,

FIG. 4a-4b show an embodiment of the hook of the invention,

FIG. 5 shows an embodiment of a hook of the invention connected to couplings, wherein the hook comprises an angle β, relative to a vertical plane (P),

FIG. 6 shows an embodiment of a hook of the invention, wherein the projecting portion comprises a dip,

FIG. 7 shows an embodiment of a hook of the invention, wherein the angle a between the base portion and the projecting portion is rounded. FIG. 7 shows that the projecting portion may have a length (x),

FIG. 8 shows a pig foot, with the position of the Achilles tendon, calcaneus, tibia, fibula and a line (I) where the foot (F) may be cut off,

FIG. 9 is a general overview of the anatomy of a pig wherein either the upper third or the lower third thereof may be processed using the processing plant and hook of the invention.

### DETAILED DESCRIPTION

The invention will now be explained in more detail below by reference to various embodiments.

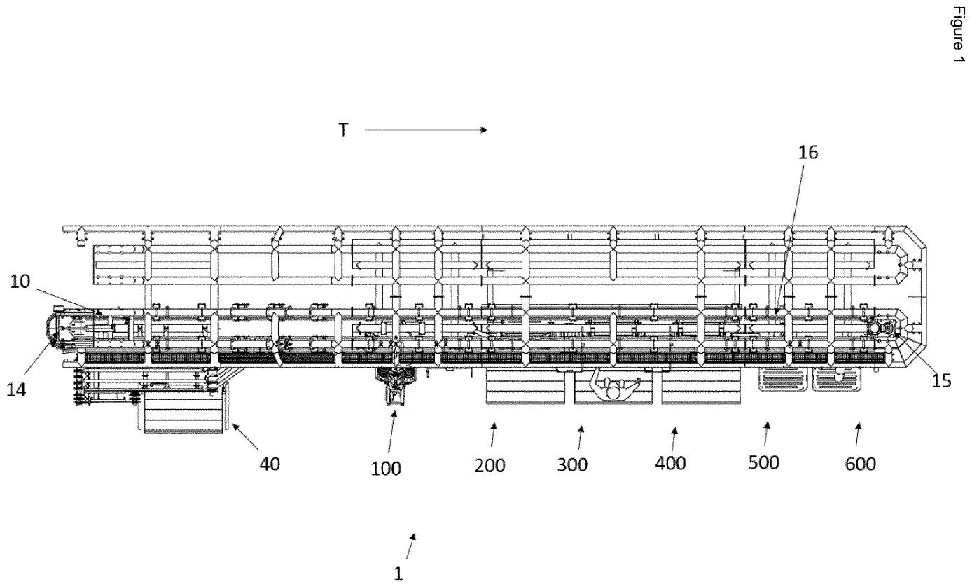

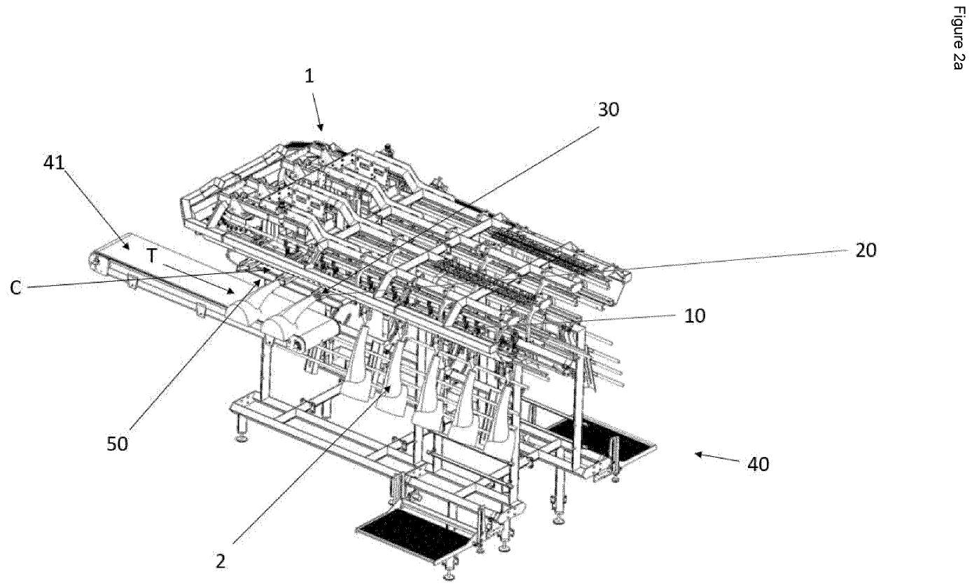

FIG. 1 generally shows a top view of an embodiment of a slaughtered pig part processing plant including an elongated frame carrying a conveyor that supports and advances a plurality of spaced apart pig part retaining assemblies referred to herein as hooks.

A hook may be defined as a pig part penetrating structure. A hook may comprise a projecting portion, configured to penetrate a pig part from one side of said pig part to the opposite side of said pig part.

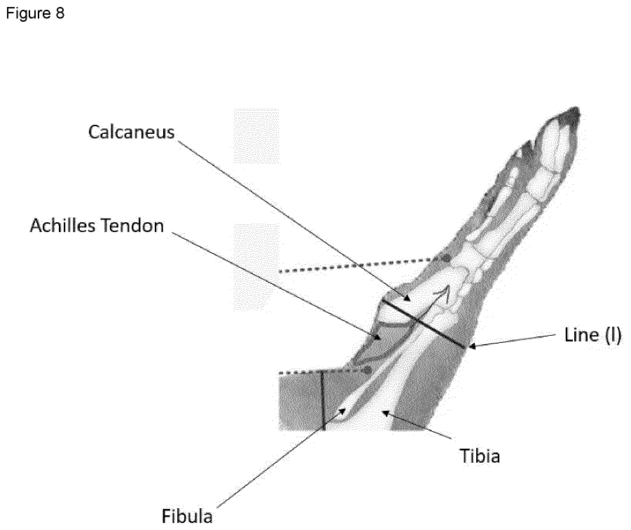

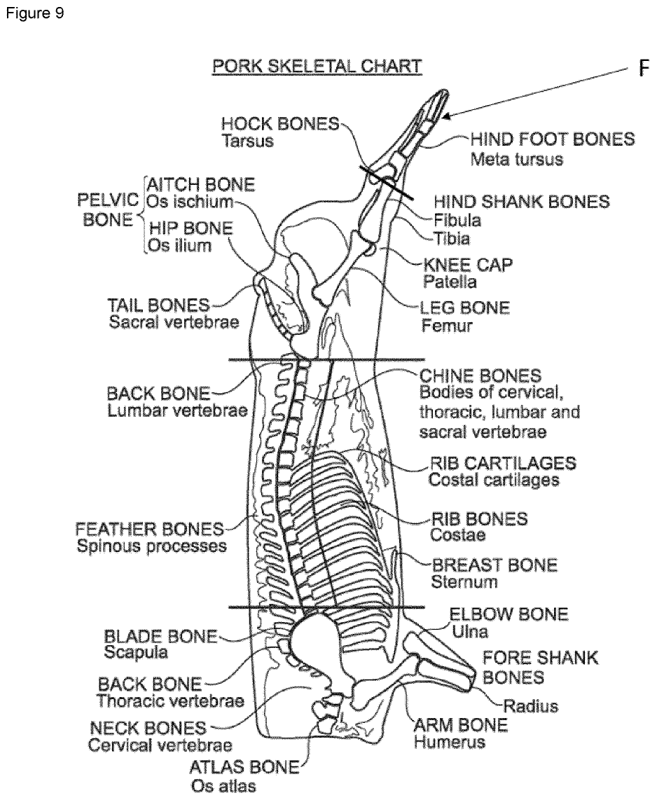

Each hook may be configured for holding a pig part, such as a ham from which the feet has been cut off and which has been tumbled. The pig part is advanced by the conveyor in a general machine direction T from a first station, where a portion of the pig part is placed on the hook, to a last station 600 where the bone of the processed pig part is removed automatically from the hooks. The pig part is normally a leg or shoulder part, such the hind shank with the hind foot or the fore shank cut off, see FIGS. 8 and 9.

Each hook may comprise a base portion and a projecting portion, and said hook may be connected to said conveyor so as to allow for a turning movement of said hook, about a first, generally horizontal axis, relative to said couplings, and parallel or substantially parallel with said machine direction.

Between the first station and the last station 600 may be a sequence of processing stations 100, 200, 300, 400, 500 for performing various cutting operations and for removing meat from the bone of the individual pig parts.

The conveyor may have a return part 16 returning the empty hooks from the last station to the first station and extending between redirecting sections 14, 15. The conveyor may be an endless structure, such as a chain, carrying the hooks via couplings and driven and guided by any conventional means, such as by rollers located at the redirecting sections.

In one embodiment as shown in FIG. 1, two independently operating processing plants 1 as described above may have their conveyors positioned back to back and be operating with a respective one of the different types of hooks described below, one plant processing hind shanks and the other plant processing fore shanks.

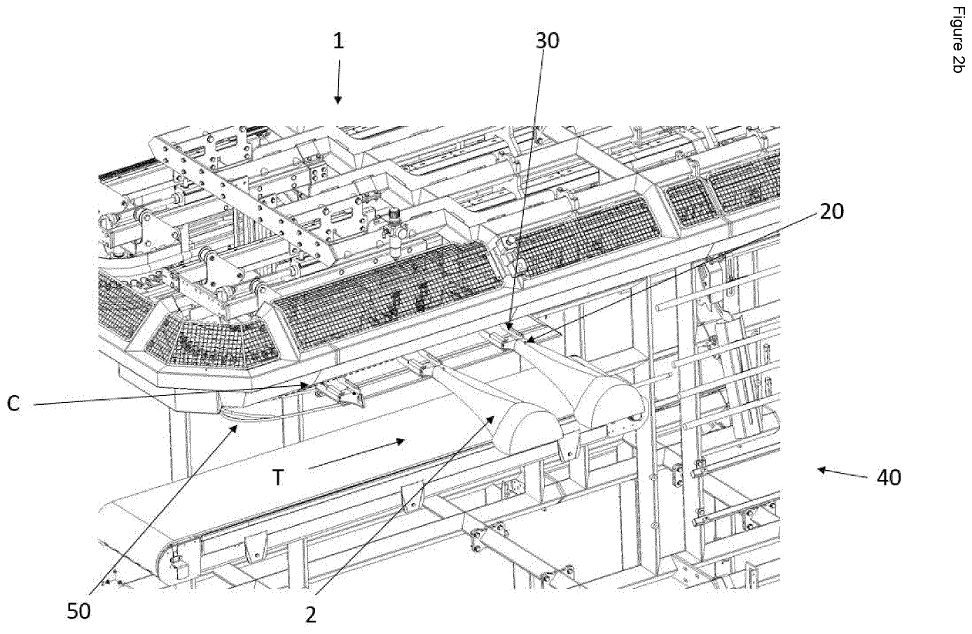

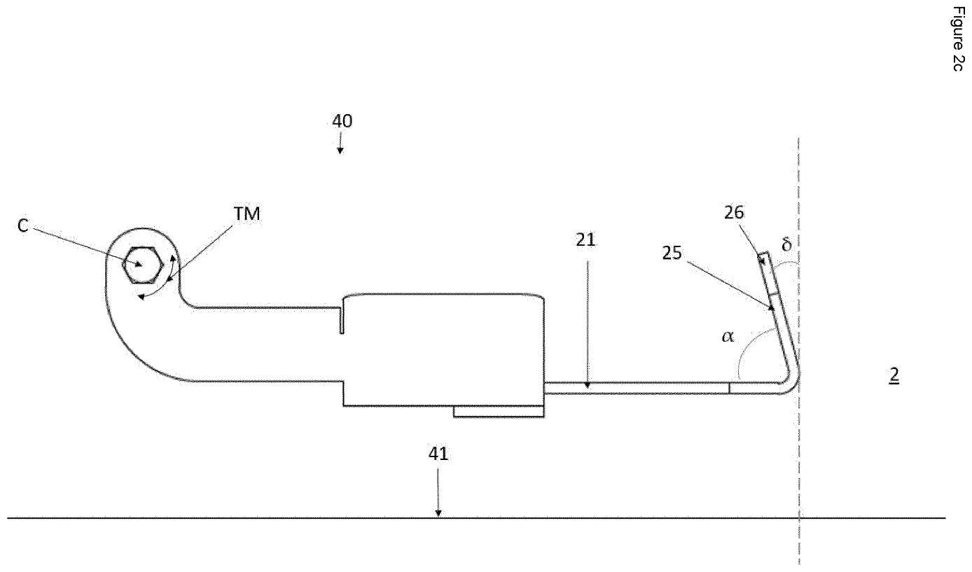

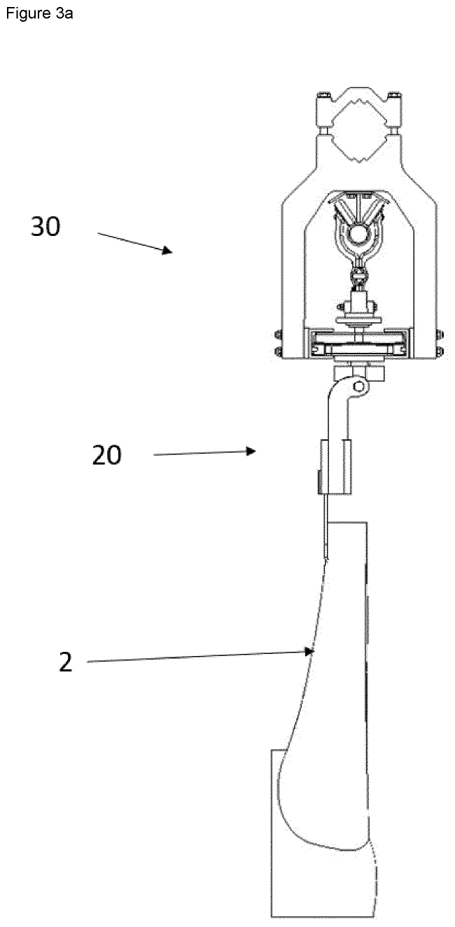

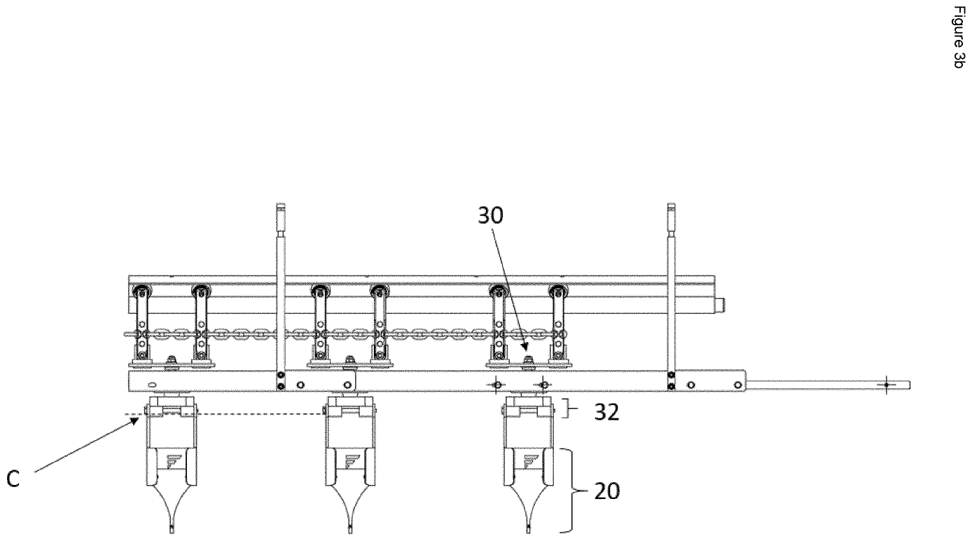

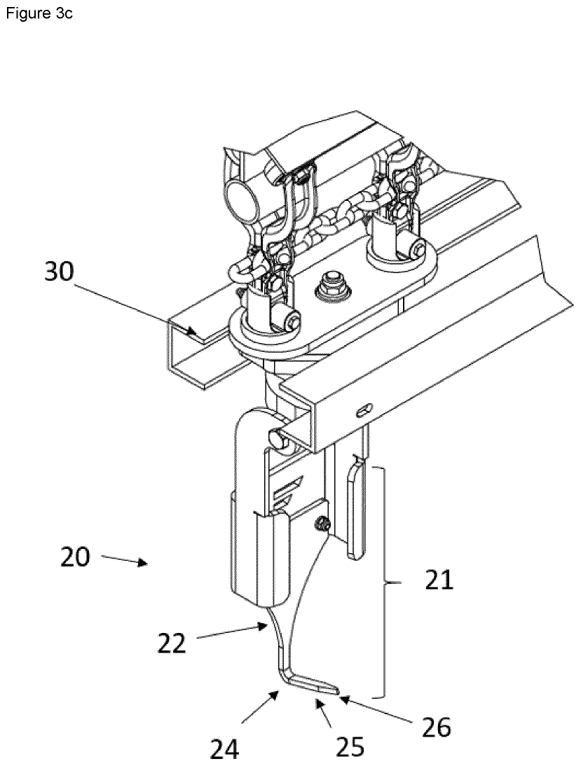

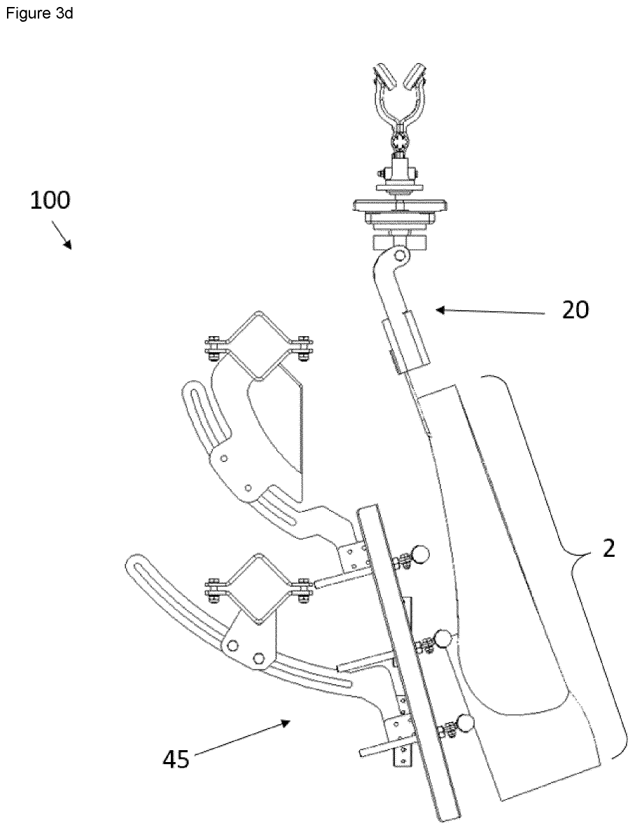

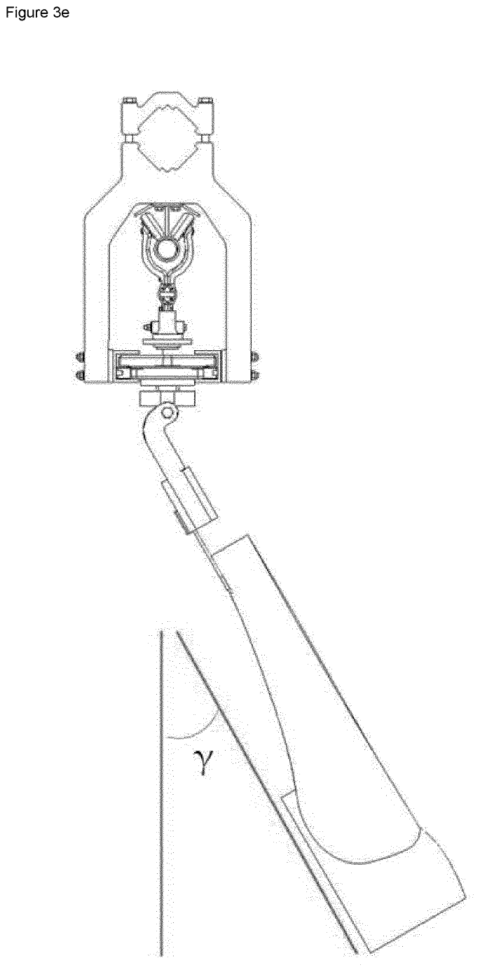

FIG. 2a-2b show a first station of an embodiment of a slaughtered pig part processing plant, with a plurality of hooks. In a first position (A) the projecting portion of said hooks is oriented horizontally, thus the hooks are placed in a pig part loading position, the conveyor belt (41) is moving in the machine direction (T), FIG. 2c shows a second pig part applying position (B) wherein the projecting portion is oriented vertically. FIG. 2c additionally shows the angle (δ) to the vertical, and the angle (α),

FIG. 2a-2b additionally show a view of the first station, showing also a suspended pig part being advanced from the first station, held by a hook.

In an embodiment, a slaughtered pig part processing plant is provided. The slaughtered pig part processing plant including at least one pig part processing station and a conveyor supporting, via respective couplings, a plurality of spaced apart hooks, each hook connected to a corresponding coupling so as to allow for a turning movement of said hook, relative to said corresponding coupling, about a first axis, said conveyor advancing said couplings with a corresponding hook in a machine direction from a first station for placing a pig part on a hook, towards a last station for removing the bone of the processed pig part from the hook, said processing plant including first guiding elements for engagement with said hooks at said first station, for bringing about said turning movement about said first axis, from a first position to a second, pig part applying position, said axis being parallel or substantially parallel with said machine direction, each hook comprising a base portion contiguous with a projecting portion, the projecting portion projecting from the base portion, and said projecting portion having a proximal end and a distal end, wherein said distal end is for pig part penetration.

In an embodiment, said hook assuming at said first station a position wherein said projecting portion is oriented at an angle (δ) to the vertical. In an embodiment, said angle (δ) to the vertical is 0-45°, 0-30°, 0-15° or about 5°.

In an embodiment, said first axis (C) is horizontal, or generally horizontal.

In an embodiment, said turning movement (TM) of said hooks from said first position (A) to said second, pig part applying position (B), is 70°-110°, 80°-100° or about 90° and/or said turning movement (TM) bringing said base portion to a horizontal or substantially horizontal position.

The distal end of said projecting portion may be pointed and/or sharpened. Said projecting portion may be straight, or said projecting portion may comprise straight portion having a length (x) of 1-15 cm, 3-12 cm, 5-10 cm or preferably about 7 cm.

In an embodiment, said pig part is half a pig or a quarter of a pig.

In an embodiment said projecting portion extends from the base portion at an angle (α). In an embodiment said hook assuming at said first station a position wherein said projecting portion is oriented at an angle (α) to the horizontal. In an embodiment said angle (α) is about 50-140°, 55-135°, 60°-130°, 65°-125°, 70-120°, 75-115°, 80-110°, 85-105° or preferably about 90°.

In an embodiment, said projecting portion extends from the base portion at an angle (β) relative to said base portion when the hook is in the first position (A), wherein said angle (β) is an angle relative to a vertical plane perpendicular to said machine direction (T). In an embodiment said angle (β) is about 1-90°, 5-85°, 10-80°, 15-75°, 20-70°, 25-65°, 30-60°, 35-55°, 40-50° or preferably about 45°.

The hooks of the invention are normally of a food compatible material. In an embodiment, said hooks are made of metal, stainless steel and/or synthetic material. In an embodiment, edges (22) of said base portion are curved. The pig part may be movable around a horizontal axis when placed on the hook.

In an embodiment, said base portion comprise two opposite flanges (23) having apertures (23′) for connecting said hook to a respective coupling. The hooks of the invention may have a height of about 20 cm, 25 cm, 30 cm, 30.6 cm, 33.1 or about 35 cm. The hook may be mounted to the coupling by a pin 31 attached to a lower structural part 32 of the coupling and received by the aperture 23′ of the flange 23 of the hook.

The plant may comprise supports for supporting said pig part during processing. In an embodiment, said supports creates an angle (γ) to the vertical of about 0-80°, 0-60°, 10-50°, 20-40° or about 30°.

In the following a method operating the plant described above will be discussed.

In an embodiment, a method of operating the plant described above is provided. The method comprises the steps of:
a. Cutting off the foot (F) of a pig part, leaving behind the Achilles tendon or part of the Achilles tendon.
b. arranging said hook in said second position (B), with the projecting portion being vertical or generally vertical,
c. pressing from above, said pig part without said foot (F) onto said distal end.

The method may additionally comprise a step, before said step b, wherein said pig part is subjected to a tumbling.

Tumbling may be defined as a process where the pig part is put into a container, which is rotated, whereby the skin of said pig part is loosened.

The projecting portion of said hook may penetrate from one side of said pig part to an opposite side of said pig part. The projecting portion of said hook may extend in between a bone and a tendon of a slaughtered pig fore or hind leg, preferably, said bone is tibia or fibula, and said tendon is the Achilles tendon. Additionally, or alternatively, said projecting portion of said hook extends into the Achilles tendon of a slaughtered pig leg.

In an embodiment, said method comprises a step of cutting a hole between the Achilles tendon and tibia, or a step of cutting a hole in the Achilles tendon, prior to said processing step (c).

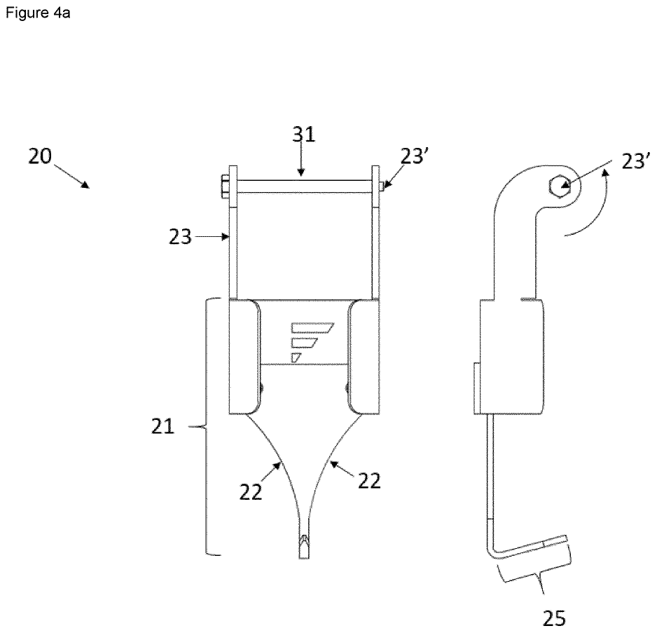

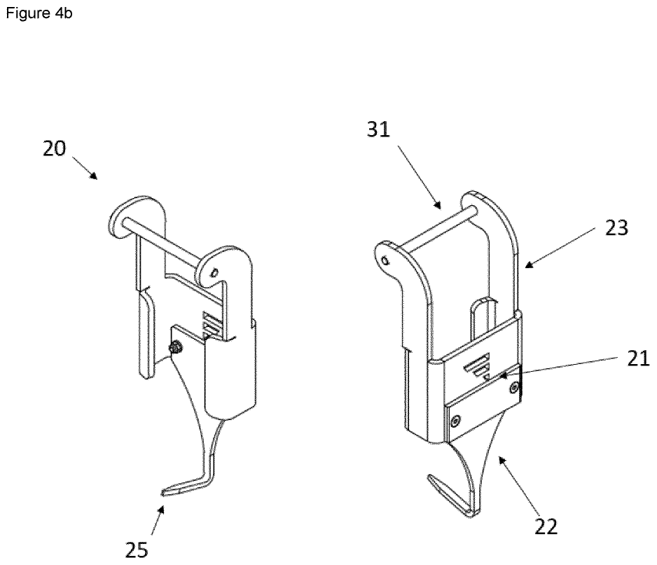

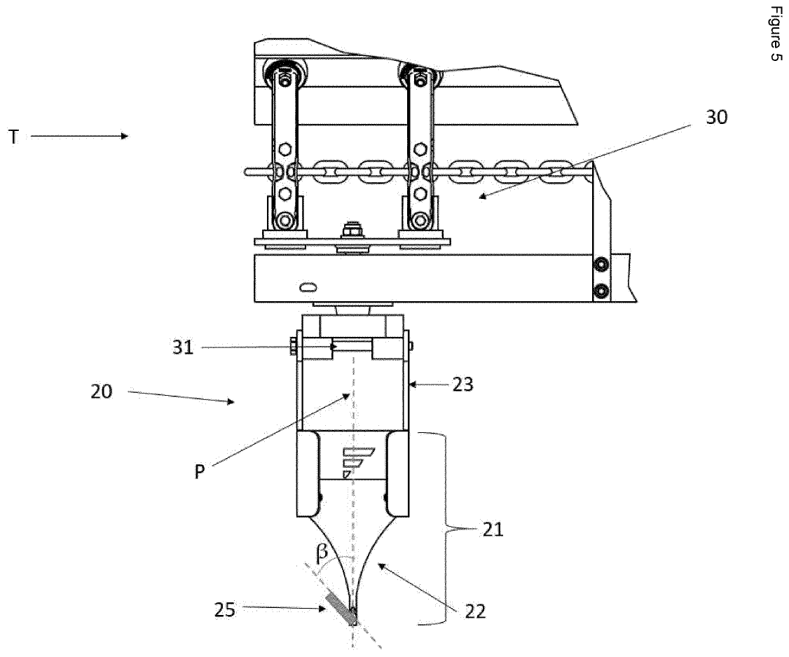

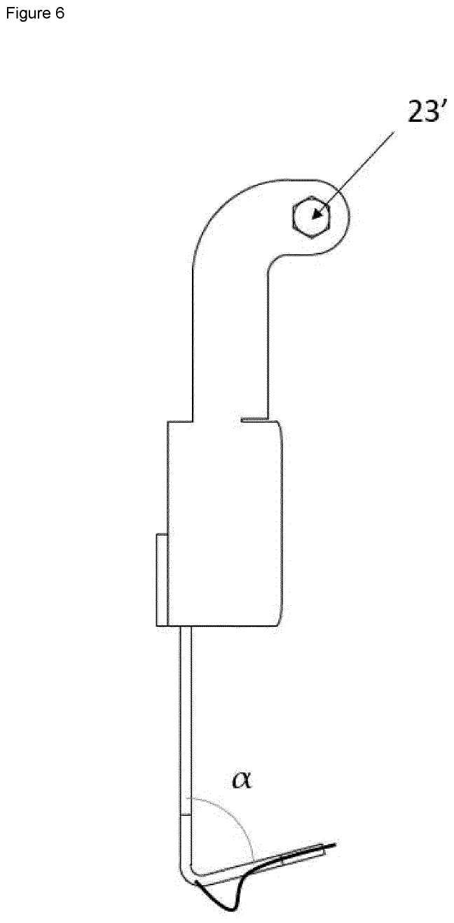

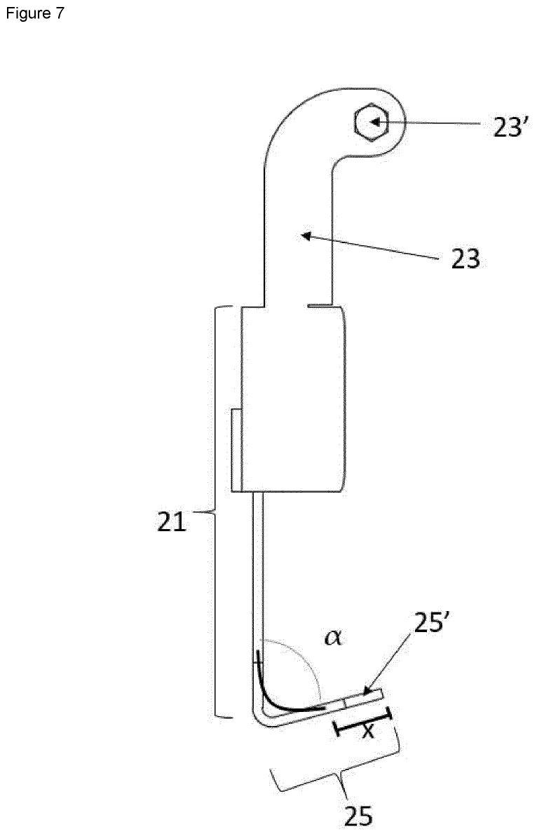

FIG. 4a-4b show an embodiment of the hook of the invention, which hook may find use in the plant of FIG. 1 or in any other slaughtered pig part processing plant of the general type that includes a conveyor frame with a conveyor for supporting a plurality of spaced apart pig part retaining assemblies and where the conveyor advances the pig parts in a machine direction from one station for introducing pig parts into the retaining assemblies, to a last station where the bones of the processed pig parts leave the retaining assemblies.

In an embodiment said hook is for retaining a slaughtered pig part to be advanced by a conveyor in a slaughtered pig part processing plant, said hook comprising a base portion and a projecting portion, wherein said projecting portion extends from the base portion in an angle (α), and wherein said hook is configured to be connected to said conveyor so as to allow for a turning movement of said hook, about a fist, generally horizontal axis (C).

The hooks described herein may be L-shaped or substantially L-shaped. In an additional embodiment of the hook, the hook is of a generally larger size, for holding on to a relatively thicker pig part, such as portion of a pig fore shank from which the foot has been previously removed.

Additionally, the hooks described herein may be used in the processing plant described in WO20187692.

1. A slaughtered pig part processing plant comprising:
a pig part processing station; and
a conveyor supporting, via respective couplings, a plurality of spaced apart hooks, each of said plurality of spaced apart hooks connected to a corresponding one of said respective couplings so as to allow for a turning movement (TM) of each of said plurality of spaced apart hooks, relative to said corresponding one of said respective couplings, about an axis (C), said conveyor advancing said plurality of couplings with a corresponding one of said plurality of space apart hooks in a machine direction (T) from a first station for placing a pig part on one of said plurality of spaced apart hooks, towards a last station for removing a bone of said pig part from said one of said plurality of spaced apart hooks; and
guiding elements for engagement with said plurality of spaced apart hooks at said first station, for bringing about said turning movement (TM) about said first axis (C), from a first position (A) to a second, pig part applying position (B), said axis (C) being parallel or substantially parallel with said machine direction (T), each of said plurality of spaced apart hooks comprising a base portion contiguous with a projecting portion comprising proximal end and a distal end, wherein said distal end is for pig part penetration.

2. The slaughtered pig part processing plant according to claim 1, one of said plurality of spaced apart hooks assuming at said first station position wherein said projecting portion is oriented at an angle (δ) to a vertical direction.

3. The slaughtered pig part processing plant according to claim 2, wherein said angle (δ) to the vertical direction is 0-45°.

4. The slaughtered pig part processing plant according to claim 1, wherein said axis (C) is horizontal, or generally horizontal.

5. The slaughtered pig part processing plant according to claim 1, wherein said turning movement (TM) of said plurality of spaced apart hooks from said first position (A) to said second, pig part applying position (B), is 70°-110°, and/or said turning movement (TM) bringing said base portion to a horizontal or substantially horizontal position.

6. The slaughtered pig part processing plant according to claim 1, wherein said distal end is pointed and/or is sharpened.

7. The slaughtered pig part processing plant according to claim 1, wherein said projecting portion is straight.

8. The slaughtered pig part processing plant according claim 1, wherein said projecting comprises a straight portion comprising a length (x) of 1-15 cm

9. The slaughtered pig part processing plant according to claim 1, wherein said pig part is half a pig or a quarter of a pig.

10. The slaughtered pig part processing plant according to claim 1, wherein said projecting portion extends from said base portion at an angle (α).

11. The slaughtered pig part processing plant according to claim 1, one of said plurality of spaced apart hooks assuming at said first station a position wherein said projecting portion is oriented at an angle (α) to a horizontal direction.

12. The slaughtered pig part processing plant according to claim 10, wherein said angle (α) is about 50-140°.

13. The slaughtered pig part processing plant according to claim 1, wherein for one of said plurality of spaced apart hooks said projecting portion extends from the base portion at an angle (β) relative to said base portion when said one of said plurality of spaced apart hooks in said first position (A), wherein said angle (β) is an angle relative to a vertical plane (P) perpendicular to said machine direction (T).

14. The slaughtered pig part processing plant according to claim 13, wherein said angle (β) is about 1-90°.

15. The slaughtered pig part processing plant according to claim 1, wherein for one of said plurality of spaced apart hooks said base portion comprises two opposite flanges having apertures for connecting said one of said plurality of spaced apart hooks to said corresponding coupling.

16. A method of operating a slaughtered pig part processing plant comprising:
a pig part processing station; and
a conveyor supporting, via respective couplings, a plurality of spaced apart hooks, each of said plurality of spaced apart hooks connected to a corresponding one of said respective couplings so as to allow for a turning movement (TM) of each of said plurality of spaced apart hooks, relative to said corresponding one of said respective couplings, about an axis (C), said conveyor advancing said plurality of couplings with a corresponding one of said plurality of space apart hooks in a machine direction (T) from a first station for placing a pig part on one of said plurality of spaced apart hooks, towards a last station for removing a bone of said pig part from said one of said plurality of spaced apart hooks; and
guiding elements for engagement with said plurality of spaced apart hooks at said first station, for bringing about said turning movement (TM) about said axis (C), from a first position (A) to a second, pig part applying position (B), said axis (C) being parallel or substantially parallel with said machine direction (T), each of said plurality of spaced apart hooks comprising a base portion contiguous with a projecting portion comprising a proximal end and a distal end, wherein said distal end is for pig part penetration;
wherein said method comprises:
cutting off a foot (F) of said pig part, leaving behind an Achilles tendon or part of said Achilles tendon;
arranging one of said plurality of spaced apart hooks in said second position (B), with said projecting portion of said one of said plurality of spaced apart hooks being vertical or generally vertical; and,
pressing from above, said pig part without said foot (F) onto said distal end of said one of said plurality of spaced apart hooks.

17. The method of operating a slaughtered pig part processing plant according to claim 16, wherein before said arranging, said pig part is subjected to a tumbling.

18. The method of operating a slaughtered pig part processing plant according to claim 16, wherein said projecting portion of said one of said plurality of spaced apart hooks penetrates from one side of said pig part to an opposite side of said pig part.

19. The method of operating a slaughtered pig part processing plant according to claim 16, wherein said projecting portion of said one of said plurality of spaced apart hooks extends in between a bone and a tendon of a slaughtered pig fore or hind leg.

20. The method of operating a slaughtered pig part processing plant according to claim 16, wherein said projecting portion of said one of said plurality of spaced apart hooks extends into an Achilles tendon of a slaughtered pig leg.

21. The method of operating a slaughtered pig part processing plant according to claim 16, further comprising cutting a hole between an Achilles tendon and tibia, or in said Achilles tendon, prior to said pressing from above.
